(19) United States
(12) Patent Application Publication
(10) Pub. No.: US 2005/0122650 A1
(43) Pub. Date: Jun. 9, 2005

(54) Portable power supply with safety switch

(76) Inventors: Max Hartwell Beasley III, Plano, TX (US); Jeffrey Warren Hains, Arlington, TX (US)

Correspondence Address: Michael P.F. Phelps, Esq.;Hunton & Williams, Suite 1200, 1900 K Street, NW, Washington, DC, 20006-1109, US

(21) Appl. No.: 10/725,515

(22) Filed: Dec. 3, 2003

(51) Int. Cl. H02H 3/24

(52) U.S. Cl. 361/90

(57) ABSTRACT

A portable electric power supply with a main contactor relay connected in electrical series with a manual safety switch and voltage sensing relay contactor between the neutral conductor and a power conductor of the power supply. A voltage sensing relay detects the voltages in the power supply and turns on the voltage sensing relay contactor when the voltages reach a minimum value. The safety switch is wired in parallel with a latching contactor. The main contactor relay activates a main power contactor and the latching contactor when the voltage sensing relay contactor and one or both of the safety switch and latching contactor are activated, and deactivates the main power contactor and latching contactor when the voltage sensing relay contactor is deactivated. When activated, the main power contactor connects power outlets to the neutral conductor and power conductors.

### FIELD OF THE INVENTION

The present invention relates generally to portable power supplies, and more specifically, to portable power supplies having protective circuits and switches to prevent injury from electrical fault conditions including momentary undervoltages and power losses.

### BACKGROUND OF THE INVENTION

During construction and maintenance projects there is often a need to provide electrical power to operate lights, hand tools and other electrical equipment. In many cases the electrical equipment is required to operate at some distance from the nearest permanent electrical outlet or supply. In some cases, local electricity is provided by individual extension cords or local generators. Unfortunately, extension cords are often unable to provide the necessary power requirements and, when many are used, can be troublesome to maintain in a safe and orderly fashion. In addition, generators are noisy, expensive to maintain and operate, and emit exhaust making them unsuitable for use in confined spaces. In light of these problems with extension cords and generators, a number of portable power supply devices have been devised to provide remote access to electrical power from a permanent or semi-permanent source. These devices typically are powered by a single high voltage and high current power cable, are hand-portable, and have a number of outlets arranged on them to which locally-operated electrical devices of various types can be connected. Typical examples of such devices are provided in U.S. Pat. Nos. 3,631,324 to Jones, 3,786,312 to Roussard, 4,318,156 to Gallagher, and 5,894,392 to McDonald, which are incorporated herein by reference.

Some prior art portable power supply devices have been equipped with safety devices to reduce the likelihood of injury caused by electrical fault conditions. For example, in U.S. Pat. Nos. 5,894,392 and 3,786,312, ground fault circuit interrupter (GFCI) breakers are incorporated into portable power supply outlets to protect against short circuits between the line and neutral conductors. U.S. Pat. No. 5,894,392 also provides a supervisory circuit that determines whether the two line conductors are properly connected by evaluating whether the sum of the two rectified line conductor circuit voltages exceeds a certain threshold level using a zener diode. The threshold voltage is only met when the two line conductors are properly connected (i.e., one has not been transposed with the neutral conductor). When the threshold voltage is met, the zener diode completes a circuit that closes contacts that connect the line conductors to the device's power outlets.

Although the prior art devices provide some protection against electrical faults and miswirings, they fail to provide any protection against dangerous situations that may be caused by temporary undervoltage and outage situations.

### SUMMARY OF THE INVENTION

The present invention provides a portable electric power supply with a power input with first and second power conductors and a neutral conductor, one or more outlets, and a main power contactor adapted to electrically connect the one or more power outlets to the neutral conductor and one or more of the first and second power conductors when the main power contactor is activated. The power supply also has a manually-operated safety switch that provides a closed circuit when manually activated and an open circuit when not manually activated and a latching contactor that provides a closed circuit when activated and an open circuit when not activated. The latching contactor is connected to provide a parallel electrical circuit with the safety switch. A voltage sensing relay contactor is also included to provide a closed circuit when activated and an open circuit when not activated. A voltage sensing relay is wired into the power supply to measure a first voltage in the first power conductor and a second voltage in the second power conductor and to activate the voltage sensing relay contactor when the first and second voltages exceed a predetermined turn-on value and deactivate the voltage sensing relay contactor when one or both of the first and second voltages falls below a predetermined turn-off value. Finally, the power supply has a main contactor relay, connected in electrical series with the safety switch and the voltage sensing relay contactor between the neutral conductor and at least one of the first and second power conductors. The main contactor relay is wired to activate the main power contactor and latching contactor when the voltage sensing relay contactor and one or both of the safety switch and latching contactor are activated, and to deactivate the main power contactor and latching contactor when the voltage sensing relay contactor is deactivated.

Various other embodiments of the invention are provided. In one embodiment, the power input is connectable to a 50 A 250VAC power supply. In another embodiment, the power supply also has one or more breakers associated with the one or more outlets. In other embodiments, the outlets include one or more GFCI-protected 20 A 120V outlets, one or more GFCI-protected 30 A 120/240V outlets, or a combination of these outlets.

In still another embodiment, the voltage sensing relay activates the voltage sensing relay contactor when the sum of the first and second voltages exceeds a predetermined turn-on value and deactivates the voltage sensing relay contactor when the sum of the first and second voltages falls below a predetermined turn-off value. In this embodiment, the power input has a rated voltage value, and the turn-on value is about 70% to about 100% of the rated voltage value. The turn-on value is also may be adjustable, and the turn-off value may not be equal to the turn-on value, and may be up to about 20% lower than the turn-on value. In one embodiment, both the turn-on value and the turn-off value are adjustable.

The power supply may also have a light adapted to be illuminated when the main power contactor is activated, and may have one or more fuses protecting one or more of the safety switch, latching contactor, voltage sensing relay contactor, voltage sensing relay, and main contactor relay.

These and other features of the invention will be readily understood from the Detailed Description that follows, along with reference to the drawings appended hereto.

### BRIEF DESCRIPTION OF THE DRAWINGS

FIG. 1 is an isometric view of an embodiment of the invention.

FIG. 2 is an isometric view of the embodiment of FIG. 1, showing the opposite side of the apparatus.

FIG. 3 is a wiring schematic of an embodiment of the invention.

### DETAILED DESCRIPTION OF THE PREFERRED EMBODIMENTS

Temporary undervoltage situations are situations that cause the supply voltage of a power supply to drop below a desired threshold level for a limited amount of time. Undervoltage situations include reductions in the source power (undervoltages) and complete losses of power (outages). For the purposes of this discussion, the terms undervoltage and outage are used synonymously. There are many examples of how a potentially dangerous undervoltage can occur on a typical industrial job site. For example the main power cord supplying electricity to a portable power supply could be pinched or crushed under a vehicle tire or track, causing a momentary short or open circuit. Undervoltages may also occur when a portable power supply is momentarily unplugged from the main power supply, when the main power cord is poorly connected or damaged, or when the main power supply is overloaded or shut down (i.e., brownouts and blackouts).

Temporary outage conditions can be dangerous to persons using equipment attached to portable power supplies and to the equipment itself. For example, during a temporary undervoltage, a power tool user whose tool has stopped operating may mistakenly assume that the power is permanently disabled by a blown fuse or breaker, and be injured by the tool when the power resumes moments later. Furthermore, equipment operators that experience temporary outages may continue to use their equipment after power resumes without properly addressing the fault, such as a damaged main power cord, that caused the temporary outage in the first place. In such circumstances the danger of a recurring outage may not be corrected before an injury or equipment damage occurs. Prior art portable power supplies provide no protection against the dangers associated with temporary outages. The present invention addresses this deficiency in the prior art.

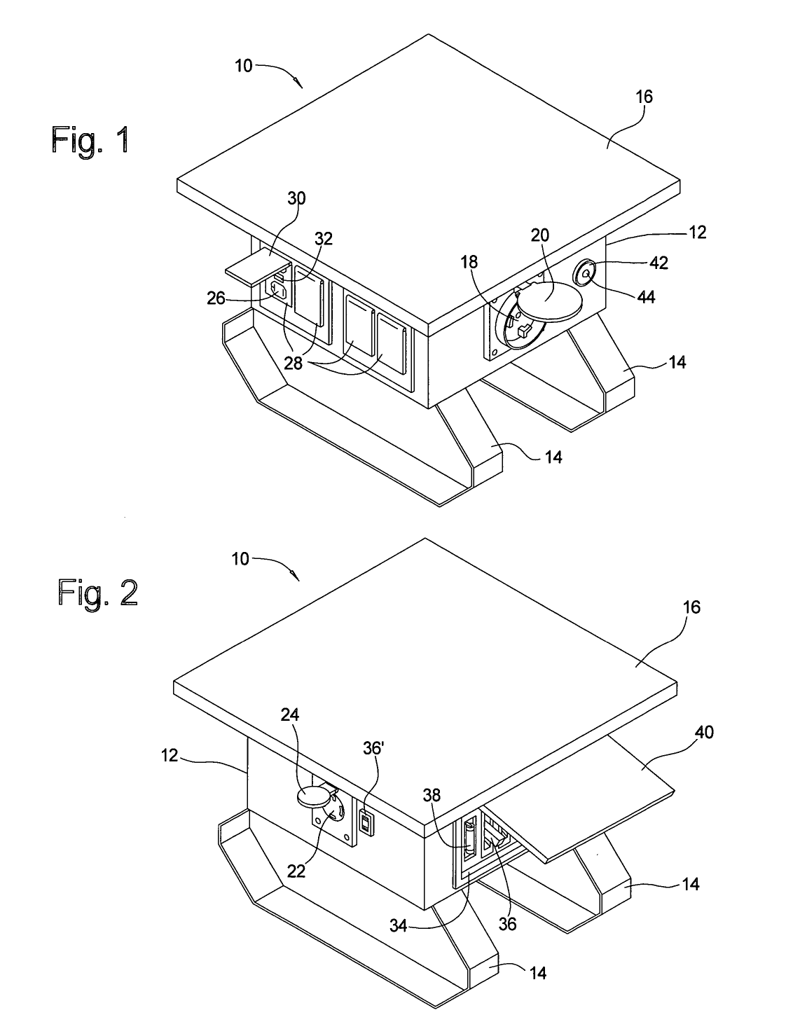

Referring now to FIGS. 1 and 2, an embodiment of a portable power supply of the present invention is described in more detail. The portable power supply 10 comprises an enclosure 12 mounted on legs 14. It will be apparent that the legs 14 may have any suitable shape and be of any suitable number; for example, a tripod design having adjustable legs or feet may be ideal for use in irregular terrain, such as rocky areas. The enclosure 12 may have an oversized top panel 16 to help shield the enclosure from water and falling objects or debris. The enclosure 12, legs 14 and top panel 16 preferably are designed to be durable to withstand the rigors of transportation and use at construction sites. Although a stamped or folded metal construction is preferred (preferably 12 to 16 gauge carbon steel), it is possible to construct all or portions of the device from plastic, wood or other materials, as will be appreciated by those of ordinary skill in the art. Preferably, the power supply 10 is made to be highly visible, such as by being powder coated with an iridescent safety orange color, which provides high visibility and a has the added benefit of increased durability and corrosion protection from the powder coating.

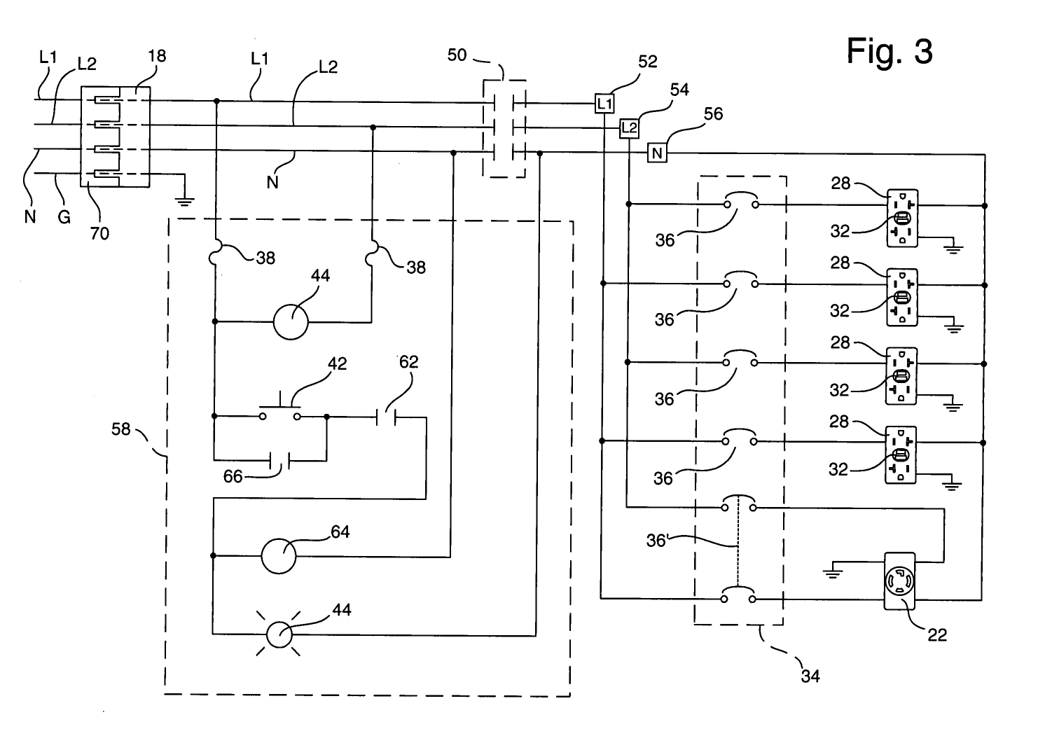

The enclosure 12 has a number of surfaces upon which are mounted one or more power inlets and outlets so that they are accessible from outside the power supply 10. While the power supply 10 of FIGS. 1 and 2 is shown having an approximately square shape, it will be readily apparent that other shapes may be selected instead. In the embodiment shown in FIGS. 1 and 2, which show opposite sides of the same power supply 10, there is a single main power inlet 18 comprising a 50 A 250VAC 3-pole, 4-wire male receptacle for receiving a conventional 250VAC female twist-lock plug (70 in FIG. 3) having two power conductors, a neutral conductor and a ground. The main power inlet 18 preferably has a weather-resistant hinged cover 20. The main power inlet 18 may be connected to a permanent power source (such as a breaker box providing utility power) or a temporary power source (such as a job site generator) through a suitable power cord.

The embodiment of FIGS. 1 and 2 has a total of nine power outlets, although other combinations and numbers of outlets may be provided. One power outlet is a 30 A 120/240V twist-lock outlet 22, which is preferably equipped with a weather-resistant hinged cover 24. The 120/240V outlet 22 may be equipped with a GFCI breaker 36′ that has a test and/or reset button mounted for easy access outside the housing 12. The remaining outlets are 20 A 120V receptacles 26, that are preferably housed in pairs in four duplex outlets 28, each of which preferably has a weather-resistant cover 30. In a preferred embodiment, the 120V duplex outlets 28 are of a conventional type including GFCI protection circuitry to provide both ground fault current protection and line-current protection. Preferably the GFCI circuitry is provided as a GFCI module 32 embedded within each duplex outlet 28 itself, but in other embodiments, the 20 A 120V receptacles may be protected by separate GFCI breakers that each protect one of more of the outlets 22, 26. Other protection circuits, such as breakers and fuses, also may be associated with the outlets 22, 26. The weather-resistant covers 20, 24, 30 of both the power inlet 18 and outlets 22, 26 may be designed to enclose the ends of the electrical cables plugged into the outlets during use to prevent the entry of dust, water and other debris. The main power inlet 18 and outlets 22, 26 also may have sealing surfaces that engage with complementary surfaces on the plugs that fit into them to provide additional sealing.

The power supply may also have one or more main power outlets (not shown) that are connected in series to the main power inlet 18 to act as a power bypass. The main power outlet can be used to “chain” together two or more power supplies 10 in a manner akin to that disclosed in U.S. Pat. No. 3,786,312.

In the embodiment of FIGS. 1 and 2, the power supply 10 also has a circuit breaker/fuse box 34 mounted such that it is accessible from outside the enclosure 12. The breaker box 34 may include a number of circuit breakers 36 and/or fuses 38 to protect the various outlets 22, 26 and circuitry contained within the enclosure 12. However, the GFCI breaker 36′ protecting the 30 A 120/240V outlet 22 may be positioned separately from the breaker box 34, and the duplex outlets 28 may have GFCI breakers 32 with their test and reset buttons in the outlets 28 themselves. The breaker box 34 also preferably has a weather-resistant cover 40.

The power supply 10 has a safety switch 42 that is used to energize the power supply 10 during initial start-up, and re-energize the power supply 10 after an undervoltage event occurs. The safety switch 42 preferably has a light 44 to indicate when the power supply 10 is energized. The light also may be located such that it is highly visible to allow as many users of the power supply 10 as possible to view it from many different angles and from a distance. The power supply 10 may also have a master power switch (not shown) to disconnect and connect the power supply wiring to the main power inlet 18. In an embodiment in which the power supply 10 has a main power outlet, so that a number of power supplies can be operated in series, the master power switch may have four positions: one in which the main power inlet 18 is disconnected from the power supply wiring, one in which the main power inlet 18 is connected only to the power supply wiring, one in which the main power inlet 18 is connected to the power supply wiring and the main power outlet, and one in which the main power inlet 18 is connected only to the main power outlet. In such an embodiment, the power supply 10 can be used to form a chain of power supplies, while not being activated for local use, and the power supply 10 can be energized for local use only, while de-energizing the main power outlet to increase safety.

Referring now to FIG. 3, the operation of the power device 10 is described in more detail in conjunction with one possible embodiment of the power supply wiring, which is preferably substantially entirely contained within the housing 12. Power is provided to the power supply 10 by attaching a power supply cord 70 to the main power inlet 18. The power supply cord 70 preferably provides 250VAC electricity through first a first power conductor L1, a second power conductor L2, a neutral conductor N and a ground G. The power conductors L1, L2 and neutral N are selectively connected to the outlets 28 and 22 through a main power contactor 50. The main power contactor default position is open, so that the main power inlet 18 is disconnected from the outlets 22, 28 until it is energized. Any suitable power contactor may be used with the present invention, provided it satisfies the power requirements of the power supply 10. The design and selection of such devices is known by those of ordinary skill in the art.

The power conductors L1, L2 and neutral N conductor preferably are connected to the outlets 22, 28 via respective distribution bars (“busses”), and breakers 36, 36′. The busses 52, 54 and 56 and breakers 36, 36′ are most conveniently located between the main power contactor 50 and the outlets 22, 28. As noted before, the breakers 36, 36′ may be enclosed in a breaker box 34 that is accessible from outside the power supply 10. The breakers 36, 36′ are selected to provide appropriate protection to each outlet 22, 28. In a preferred embodiment, the breakers comprise four 20 A breakers 36, each of which provides protection to one duplex 20 A 120V outlet 28, and one 30 A GFCI protected breaker 36′ for protecting the 30 A 120/240V outlet 22. As noted before, the outlets 28 also may be provided with built-in GFCI breakers 32. Fuses 38 (FIG. 2) also may be used in conjunction with or in lieu of the breakers 36, 36′, or the outlets 22, 28. Although it would be possible to provide an embodiment of the present invention in which the outlets 22, 26 are not protected by breakers or fuses, or are protected solely by non-GFCI breakers, the Unites States safety regulations require all temporary branch power devices to have GFCI protection, and therefore such an embodiment is not preferred. The selection and use of busses, breakers, fuses and the like are understood by those of ordinary skill in the art and a detailed description of these devices is not necessary here.

While the breakers 36 and GFCI breakers 32, 36′ are useful to provide protection from short circuits and overvoltage situations, they are not well suited to prevent injuries or damage that may occur as a result of low voltages and improper wiring or temporary undervoltage situations. As such, the power supply 10 of the present invention further comprises a safety circuit 58 that can be adapted to provide various additional protections to the power supply 10 and its users.

The safety circuit 58 comprises a voltage sensing relay (“VSR”) 60, a VSR contactor 62, a safety switch 42, a main contactor relay 64 and a latching contactor 66. The VSR 60 activates the VSR contactor 62 (which defaults to an open circuit), and the main contactor relay 64 activates the main power contactor 50 and the latching contactor 66 (which also default to open circuits). In general terms, the safety circuit operates when the VSR 60 detects proper voltages in the first conductor L1 and second conductor L2 and closes the VSR contactor 62. Once the VSR contactor 62 is closed, the main contactor relay 64 can be energized when a user operates the safety switch 42. The safety switch 42 is of the “momentary on” type, that provides a closed circuit across its terminals only while it is being physically operated, and returns to an open position when it is not depressed or toggled. When the safety switch 42 is operated, the main contactor relay 64 closes the main power contactor 50, energizing the outlets 22, 28. The main contactor relay 64 also closes the latching contactor 66, which maintains (or “seals”) the circuit between the main contactor relay 64 and the power conductors L1, L2 once the safety switch 42 is no longer being physically operated.

The latching contactor 66 may be an auxiliary, electrically isolated contact that is operated simultaneously with or by the main power contactor 50. As such, when it is described herein that the main contactor relay 64 activates the latching contactor 66, it will be understood that this activation may occur through one or more intermediate parts or circuits. Of course, the same is true for the activation of all of the parts of the present invention, and the term activate is intended to include activation through an intermediate medium. The latching contactor 66 and safety switch 42 provide parallel electrical paths to the main contactor relay 64, as shown in FIG. 3. Although FIG. 3 shows the latching contactor 66 and safety switch 42 both being attached to the same lead coming from the first power conductor L1, it would also be possible to attach either the safety switch 42 or the latching contactor 66 to a lead coming from the second power conductor L2. This is true because one power conductor L1, L2 can be used to provide the safety switch circuit, which the other conductor can be used to provide power to the latching contactor circuit, provided the leads are electrically isolated from the power conductors L1, L2 and/or rectified to prevent the two out-of-phase power conductors from shorting when both the safety switch 42 and latching contactor 66 are activated. Other variations such as this may also be possible, and it will be understood that all such variations will comprise parallel electrical paths to the main contactor relay 64, even if such paths are not truly “parallel” in the strictest electrical sense. Furthermore, although the safety circuit 58 is shown in FIG. 3 with the VSR contactor 64 located serially between the main contactor relay 64 and the safety switch 42/latching contactor 66 pair, it will be apparent that the main contactor relay 64, VSR contactor 62 and safety switch 42/latching contactor 66 pair can be arranged in any suitable electrically serial order between the power conductors L1, L2 and neutral conductor N.

Once energized, the safety circuit 58 maintains the connection of the main power contactor 50 until the VSR 60 detects an undesirable voltage or voltages in the power conductors L1, L2 and deactivates the VSR contactor 66, or until the neutral conductor N is interrupted, deactivating the main contactor relay 64. Either of these conditions will interrupt the circuit to the main contactor relay 64, thereby deactivating the main contactor relay 50, the main power contactor 50 and the latching relay 66. A manual shutoff switch (not shown) also may be provided to manually open the circuit and deactivate the device.

In a preferred embodiment, the safety circuit 58 has a light 44 to indicate when the power supply 10 is energized. In addition, the safety circuit preferably has fuses 36 to protect the safety circuit 58. Preferred fuses are fast blow 2 A fuses, although fuses of other ratings and types may be used according to the details of the safety circuit 58, as will be understood by those of ordinary skill in the art.

Various protection features are provided by the safety circuit 58. First, it will be readily seen that by wiring one pole of the main contactor relay 64 to the neutral conductor N, the safety circuit 58 will not energize the power supply 10 if there is a dangerous open neutral condition. Second, the safety circuit 58 will only energize the main power contactor 50 if the first and second power conductors L1, L2 are properly wired, as detected by the VSR 60. This prevents operation when one of the first and second power conductors L1, L2 is switched with the neutral conductor N, which can cause the GFCI circuit breakers to malfunction or otherwise cause damage or injury.

The design and selection of voltage sensing relays is well known in the art, and the VSR 60 of the present invention can be designed to operate in various ways to ensure that the first and second power conductors L1, L2 are properly wired. In various embodiments, the VSR may use solid-state circuitry, rectifiers and op-amps, MOSFET circuitry, diode bridges and/or voltage threshold zener diodes to measure and compare the voltages in the power conductors L1, L2. An example of such a system is provided in U.S. Pat. No. 5,894,392 to McDonald, which is incorporated herein by reference, which uses a diode bridge arrangement that converts the AC voltages in the power conductors L1, L2 into DC voltage, adds the voltages, and applies them to a zener diode that has a voltage threshold above a desired minimum value. The minimum value is selected to be above the voltage that can reasonably be present in a single one of the power conductors L1, L2, so that if one of the power conductors is not properly wired, then the minimum voltage will not be attainable and the VSR 60 will not energize the power supply 10. Alternatively, the VSR 60 may operate by separately measuring each of the voltages (rather than summing the voltages) and determining whether each power conductor L1, L2 meets a minimum desired voltage value before activating the VSR conductor 62. In such an embodiment, the power supply 10 may also be equipped with a pair of lights that indicate the status of each power conductor L1, L2 to assist with troubleshooting the system. Although various schemes for operating the VSR 60 are described herein, the design and use of VSRs are well-known in the art, and any other suitable VSR construction, device or operating method also may be used with the present invention.

In a preferred embodiment, the power supply 10 is intended to distribute power from a 250VAC two phase input in which the first and second power conductors L1, L2 each provide approximately 120 volts AC. In this embodiment, the VSR 60 is preferably configured to energize at a combined voltage of about 192 volts, which is about 80% of the rated (nominal) supply voltage. This minimum turn-on voltage threshold ensures that the power conductors L1, L2 are properly wired, while maintaining some flexibility to allow the power supply 10 to energize even if the voltage is somewhat lower than the rated value, as may happen from time to time during heavy usage. The turn-off voltage may simply equal the turn-on voltage, however it is preferably set marginally below the turn-on voltage to accommodate brief fluctuations in the supply voltage, and to prevent damage to tools or equipment that may result from operating at low voltages. In the preferred embodiment, the VSR 60 is configured to de-energize when the combined voltage in the power conductors L1, L2 drops below about 95% of the turn-on voltage threshold (about 182.4 volts). The turn-off voltage can be set by changing the VSR's hysteresis setting, and a hysteresis setting of 5% (which represents a 5% reduction in the turn-on voltage) will set the turn-off voltage at the preferred value of 95% of the turn-on voltage.

In a preferred embodiment, the VSR 60 is adjustable to allow the power supply manufacturer or user to adjust the VSR's turn-on voltage and turn-off voltage. Preferably, the turn-on voltage can be adjusted from at least about 70% of the rated voltage up to about 100% of the rated voltage. In the embodiment described immediately above, the turn-on voltage value can be adjusted from about 168 volts to about 240 volts. It is also preferred that the VSR hysteresis setting can be adjusted from about 0% (where the turn-off voltage approximately equals the turn-on voltage) to about 20% or more (where the turn-off voltage equals about 80% of the turn-on voltage). Based on 0%-20% VSR hysteresis adjustability, in the immediately preceding embodiment the preferred turn-off voltage values can be varied from about 134.4 volts to about 240 volts.

While the discussion herein has referred only to measuring the magnitudes of the voltages in the power conductors L1, L2, it will also be appreciated that the VSR 60 can be programmed or configured to detect and operate based on other conditions in the power conductors L1, L2, such as current and voltage phase conditions.

As previously noted, the safety circuit 58 includes a safety switch 42 for initially energizing the power supply 10 and re-energizing the power supply 10 after an undervoltage, and a latching contactor 66 for maintaining the power supply 10 in the energized state during use. The latching contactor 66 is closed by the main contactor relay 64, which, in turn, relies on the VSR contactor 62 to maintain its connection to the power conductors L1, L2. As such, when the VSR 60 detects an undesirable undervoltage condition, such as a reduction in voltage below the VSR's turn-off voltage or a complete outage, the VSR contactor 62 opens, cutting off power to the main contactor relay 64, and thereby opening both the main power contactor 50 and the latching contactor 66 and de-energizing the power supply 10. When the voltage returns to a level sufficient to satisfy the VSR's turn-on voltage requirements, the VSR 60 will activate the VSR contactor 62, but the power supply 10 will remain de-energized until the safety switch 42 is once again physically operated by a user.

This manual reset feature of the present invention provides a number of benefits to the portable power supply 10. For example, by ensuring that a user must actively re-energize the power supply 10, the present invention helps prevent injuries and damage that may be caused when power is automatically and unexpectedly returned to power tools and other electrical devices operating from the power supply 10 after a momentary undervoltage situation. This also encourages users to return to the power supply 10 to address the source of the problem directly, which can be particularly important when the power supply users are not within sight of the power supply and unable to see whatever may be causing the power interruption or undervoltage condition. To further encourage safe use of the power supply 10, it may also be desirable to print or emboss, directly on the power supply 10, re-energizing instructions that instruct the operator to inform all users before re-energizing the unit.

As described herein, a preferred embodiment of the safety circuit 58 provides at least four different modes of safety management. First, the safety circuit 58 uses control logic that will not allow the unit to energize when one of the first power conductor L1 or second power conductor L2 is switched with the neutral conductor N. Second, the safety circuit 58 prevents energizing when the neutral conductor N is not connected at all (i.e., an open neutral condition). Third, the safety circuit 58 prevents operation during undervoltage conditions. And fourth, the safety circuit 58 prevents undesirable restarts following undervoltage conditions. Of course, these safety features are in addition to the GFCI breakers, conventional breakers and fuses that may be used with the device. Furthermore, other embodiments of the safety circuit 58 may be constructed in which the safety circuit 58 provides fewer safety features, or features in addition to those described herein.

Other embodiments, uses, and advantages of the invention will be apparent to those skilled in the art from consideration of the specification and practice of the invention disclosed herein. Furthermore, the present invention may be used in combination with any suitable prior art apparatus or methods, and any description herein of drawbacks or limitations of the prior art are not to be understood as limiting the scope of the present invention to necessarily exclude embodiments of the invention that have these or other drawbacks or limitations. The specification should be considered exemplary only, and the scope of the invention is accordingly intended to be limited only by the following claims and equivalents thereof.

1. A portable electric power supply comprising:
a power input having first and second power conductors and a neutral conductor;
one or more outlets;
a main power contactor adapted to electrically connect the one or more power outlets to the neutral conductor and one or more of the first and second power conductors when the main power contactor is activated;
a manually-operated safety switch providing a closed circuit when manually activated and an open circuit when not manually activated;
a latching contactor providing a closed circuit when activated and an open circuit when not activated, the latching contactor being connected to provide a parallel electrical circuit with the safety switch;
a voltage sensing relay contactor providing a closed circuit when activated and an open circuit when not activated;
a voltage sensing relay adapted to measure a first voltage in the first power conductor and a second voltage in the second power conductor and to activate the voltage sensing relay contactor when the first and second voltages exceed a predetermined turn-on value and deactivate the voltage sensing relay contactor when one or both of the first and second voltages falls below a predetermined turn-off value; and
a main contactor relay, connected in electrical series with the safety switch and the voltage sensing relay contactor between the neutral conductor and at least one of the first and second power conductors, the main contactor relay being adapted to activate the main power contactor and latching contactor when the voltage sensing relay contactor and one or both of the safety switch and latching contactor are activated, and to deactivate the main power contactor and latching contactor when the voltage sensing relay contactor is deactivated.

2. The portable power supply of claim 1, wherein the power input is connectable to a 50 A 250VAC power supply.

3. The portable power supply of claim 1, further comprising one or more breakers associated with the one or more outlets.

4. The portable power supply of claim 1, wherein the outlets comprise one or more 20 A 120V outlets, each having an associated GFCI breaker.

5. The portable power supply of claim 1, wherein the outlets comprise one or more 30 A 120/240V outlets, each having an associated GFCI breaker.

6. The portable power supply of claim 1, wherein the outlets comprise one or more 20 A 120V outlets and one or more 30 A 120/240V outlets, each of the outlets having an associated GFCI breaker.

7. The portable power supply of claim 1, wherein the voltage sensing relay is adapted to activate the voltage sensing relay contactor when the sum of the first and second voltages exceeds a predetermined turn-on value and deactivate the voltage sensing relay contactor when the sum of the first and second voltages falls below a predetermined turn-off value.

8. The portable power supply of claim 7, wherein the power input has a rated voltage value, and the turn-on value is about 70% to about 100% of the rated voltage value.

9. The portable power supply of claim 7, wherein the turn-on value is adjustable.

10. The portable power supply of claim 7, wherein the turn-off value is not equal to the turn-on value.

11. The portable power supply of claim 10, wherein the turn-off value is up to about 20% lower than the turn-on value.

12. The portable power supply of claim 10, wherein the turn-on value and turn-off value are adjustable.

13. The portable power supply of claim 1, further comprising a light adapted to be illuminated when the main power contactor is activated.

14. The portable power supply of claim 1, further comprising one or more fuses protecting one or more of the safety switch, latching contactor, voltage sensing relay contactor, voltage sensing relay, and main contactor relay.
